(19) United States
(12) Patent Application Publication
(10) Pub. No.: US 2011/0194605 A1
(43) Pub. Date: Aug. 11, 2011

(54) METHOD FOR VIDEO-CODING A SERIES OF DIGITIZED PICTURES

(75) Inventors: Peter Amon, München (DE); Jürgen Pandel, Feldkirchen-Westerham (DE)

(73) Assignee: Siemens Aktiengesellschaft, Munich (DE)

(21) Appl. No.: 12/448,081

(22) PCT Filed: Oct. 15, 2007
(86) PCT No.: PCT/EP2007/060957

§ 371 Date: Jan. 20, 2011

(30) Foreign Application Priority Data
Dec. 8, 2006 (DE) 10 2006 057 983.6

(51) Int. Cl. H04N 7/32

(52) U.S. Cl. 375/240.13; 375/E07.243

(57) ABSTRACT

Groups of pictures are formed, each group including successive pictures in an original chronological order which is coded by forming a prediction structure with at least one picture as an intra-frame, each being intra-coded, while other pictures in the group are inter-frames, each predicted from and inter-coded in relation to at least one reference frame. The prediction structure is designed such that each intra-frame is a reference frame from which at least one picture of a picture group that precedes the intra-frame as well as the least one picture of the group of pictures that succeeds the intra-frame are predicted. The inter-frames include several non-references pictures from which no pictures of the sequence are predicted. A transmission sequence having a chronological transmission order is formed from the coded pictures of the group of pictures, at least some of the coded non-referenced pictures being the first pictures of the transmission order.

### CROSS REFERENCE TO RELATED APPLICATIONS

This is the U.S. national stage of International Application No. PCT/EP2007/060957, filed Oct. 15, 2007 and claims the benefit thereof. The International Application claims the benefit of German Application No. 10 2006 057 983.6 filed on Dec. 8, 2006, both applications are incorporated by reference herein in their entirety.

### BACKGROUND

Described below is a method for video-coding a series of digitized pictures, to a method for transmitting the pictures and to a method for decoding the coded pictures. Also described below is a corresponding transmitter for transmitting the coded pictures and to a corresponding receiver for receiving and decoding the transmitted coded pictures.

A multiplicity of methods exist for the video coding of digitized pictures. Some of these methods are defined in corresponding standards, e.g. the standard H.264/MPEG-4 AVC. In known video-coding methods, the digitized pictures are arranged into groups of pictures (GOP=group of pictures), within which the individual pictures are coded. In order to ensure efficient coding, only a selection of pictures is completely intracoded, irrespective of the other pictures of the series. The remaining pictures are the subject of a prediction, in which movement vectors are specified for a relevant picture, the movement vectors describing the displacement of picture blocks relative to a reference picture. In this way, a predicted picture is determined, the prediction error between the original picture and the predicted picture being coded and transferred with the movement vectors. In a group of pictures, the pictures that have been coded using a prediction are called interpictures, because they are coded relative to one or more reference pictures.

Coded video contents can be transferred using broadcast channels, for example, as a result of which any users can receive the corresponding coded contents. In this context, the related art discloses the Multimedia Broadband Multicast Service (MBMS), which will be used in the future to transfer coded video contents via mobile radio networks. When transferring via broadcast channels, the problem arises that a systematic delay occurs when a corresponding user terminal is used to connect to a broadcast channel. This delay occurs inter alia because a Random Access Point must be found within the coded video stream, from which point the video decoder receiving the video data stream can process the video data stream. This type of delay is called Video Tune-in Delay. In this case, the Random Access Points are the above-described intrapictures, which are coded while disregarding other pictures. Because only some of the pictures are intrapictures, there is consequently a delay when connecting to a broadcast channel until a corresponding intrapicture is received.

When transferring coded video contents, use is often made of error correction methods, in particular Forward Error Correction (FEC), this being sufficiently well known from the related art. In the case of such error protection methods, provision is made for transferring redundancy packets, by which error correction for video pictures can be performed in the event of an invalid transfer, in addition to data packets containing video pictures. When error correction methods are used, it is necessary to wait a certain time, until sufficient video data and redundancy data is received, in order to carry out the error correction. This results in a further delay, which is also called Initial Delay.

With reference to FIGS. 1 to 4, the following describes various approaches from the related art, by which it is possible to reduce the above-described delay of an coded video stream when connecting to a broadcast channel.

FIG. 1 shows a known prediction structure as per the related art for coding a group of pictures GOP. Here and in the following, intrapictures are designated by the reference sign 1×(x=whole number) and interpictures are designated by the reference signs Px or Nx. The pictures having the reference sign Px here are interpictures from which further pictures of the group of pictures GOP are predicted, while the pictures having the reference sign Nx are non-referenced pictures from which no further pictures of the group of pictures GOP are predicted. Furthermore, the series of pictures represented in all illustrations are reproduced in the original order of the video stream, i.e. in the natural temporal order, in the same way as the pictures of the series of pictures follow each other. In other words, the time axis in all of the following illustrations runs in a horizontal direction from left to right, wherein higher numbers of corresponding pictures represent later time points. The arrows in all of the following illustrations indicate which pictures are used for predicting a picture. In other words, the arrows point from a reference picture, from which the prediction is taken, to the predicted picture which is predicted from the reference picture.

In the known prediction structure according to FIG. 1, in which the group of pictures GOP consists of eight pictures, for example, the first picture I0 of the series of pictures is intracoded and all subsequent pictures P1 to N7 are intercoded, the temporally preceding picture being used for prediction in each case. The group of pictures GOP is usually transferred in the order illustrated in FIG. 1, redundancy information FEC for error protection being added again at the end of the transfer. The known transfer order is therefore as follows:

I0 P1 P2 P3 P4 P5 P6 N7 FEC.

In this context, “FEC” is understood to mean error protection data which can be used for reconstructing invalid data of the GOP.

According to the related art, the pictures can also be transferred in a modified transfer order, which is the reverse order of the known transfer order and is therefore as follows:

N7 P6 P5 P4 P3 P2 P1 I0 FEC.

As a result of this modified transfer order, when connecting into a group of pictures GOP, it is possible to decode at least the pictures received at the end, because these pictures require only a small amount or even none of the information from other pictures. As in the known transfer order, the redundancy data FEC is likewise transmitted at the end when using the modified transfer order.

Dong Tian, Vinod Kumar M V, Miska Hannuksela, Stephan Wenger, Moncef Gabbouj, “Improved H.264/AVC Video Broadcast/Multicast”, in Proceedings of SPIE Visual Communications and Image Processing 2005 (VCIP 2005), Bejing, China, July 2005, further proposes a predication structure which is modified relative to that in FIG. 1 and is illustrated in FIG. 2. According to this prediction structure, the series of pictures contains a plurality of non-referenced pictures N1, N3, N5, N7 and N8, from which no further pictures of the series are predicted. Moreover, since the pictures P2, P4, P6 and N8 are no longer predicted from the directly preceding picture, the pictures I0 and P4 are used more than once for predicting temporally later pictures.

Tian et al. additionally disclose a further prediction structure in the form of so-called Multiple Reference Frames, the prediction structure being shown in FIG. 3. According to this structure, an interpicture is predicted from a plurality of other pictures, and therefore a plurality of arrows terminate at an interpicture. For example, the interpicture N5 is predicted from the temporally preceding picture P4 and the temporally succeeding pictures P6 and N8. In this case, the prediction using Multiple Reference Frames must not be confused with the bidirectional prediction, which is known from the related art and in which the individual blocks of a picture are predicted from the blocks of two different pictures by weighted sums. In the case of prediction using Multiple Reference Frames, each picture block of the relevant interpicture is only ever predicted from a single picture, wherein a different picture, from which the corresponding picture block is predicted, can nonetheless be used for each picture block.

The prediction structure according to FIG. 3 also contains non-referenced pictures N1, N3, N5, N7 and N8. The pictures of the groups of pictures as per FIGS. 2 and 3 are typically transferred in the order in which the stream is coded on the basis of its prediction structure. The known transfer order in this context is as follows:

I0 P2 N1 P4 N3 P6 N5 N8 N7 FEC1 FEC2.

In this context, the redundancy information is divided into the two redundancy blocks FEC1 and FEC2. In this context, the first redundancy block FEC1 protects the pictures I0, P2, P4, P6 and N8, while the second redundancy block FEC2 protects the pictures N1, N3, N5 and N7.

The prediction structures in FIGS. 2 and 3 provide temporally scalable video coding, featuring a plurality of resolution levels. In the first resolution level, only the intrapicture I0 is transferred in this context. In the second resolution level, the prediction pictures P2, P4, P6 and N8 are transferred in addition to the intrapicture I0, and in the third resolution level, the non-referenced pictures N1, N3, N5 and N7 are transferred in addition to the pictures I0, P2, P4, P6 and N8. In order to achieve a minimal delay when connecting into a GOP which is currently being transferred, the pictures can be arranged in a modified transfer order as follows:

FEC2 N1 N3 N5 N7 FEC1 N8 P6 P4 P2 I0.

The pictures are arranged into subsequences in descending order of the resolution levels here, such that the pictures belonging to the highest resolution level, specifically N1, N3, N5 and N7, are transferred first and the pictures belonging to the next lower resolution level, specifically the pictures N8, P6, P4 and P2, are transferred next. Finally, the intrapicture I0 is transferred at the end of the transfer order. In addition, the redundancy blocks of the corresponding resolution level are always arranged at the beginning of the subsequence of pictures belonging to the relevant resolution level.

As a result of the above-modified transfer order, when connecting into a GOP at the beginning of the GOP, e.g. within the subsequence of the pictures N1, N3, N5 and N7, display of the pictures is in particular still possible with limited resolution because the pictures of the lower resolution are transferred later and do not require information from the preceding pictures. However, the above prediction structures according to FIGS. 2 and 3 have the disadvantage that, when connecting into a GOP, uneven playback of the pictures can occur. For example, if only the pictures P2 and I0 are received because they are transferred at the end of the GOP, these pictures are initially played back with half the temporal resolution. However, because the pictures are situated at the beginning of the GOP in the natural order of the video stream, a very large gap occurs before the pictures of the next GOP are displayed.

The related art also discloses the prediction structure which is shown in FIG. 4 and is described in C. Bergeron, C. Lamy-Bergot, G. Pau and B. Pesquet-Popescu, “Temporal Scalability through Adaptive M-Band Filter Banks for Robust H.264/MPEG4 AVC Video Coding”, EURASIP Journal on Applied Signal Processing, vol. 2006, Article ID 21930, 11 pages, 2006. This shows a GOP of fifteen pictures, wherein the intrapicture I7 is not now arranged at the beginning of the GOP, but in the middle. This prediction structure likewise allows temporal scalability. In this context, only the intrapicture I7 is transferred in the lowest resolution level, the further prediction pictures P1, P5, P9 and P13 are transferred in addition to the picture I7 in the second resolution level, the pictures P3 and P11 are additionally transferred in the third resolution level, and the non-referenced pictures N0, N2, N4, N6, N8, N10, N12 and N14 are additionally transferred in the highest resolution level. The prediction structure according to FIG. 4 has the disadvantage that the temporal scaling is not regular, since the number of pictures in each resolution level (excluding the lowest) is not divisible by a common factor. For example, if the group of pictures is transferred using the second-highest resolution level (i.e. the pictures N0 to N14 are omitted), a gap of two pictures occurs between two GOPs, whereas a gap of only one picture ever occurs within each GOP. This is because the pictures at both ends of a GOP are omitted in each case in the second-highest resolution level.

The method addresses the problem of ensuring smooth playback of the video pictures with minimal delay when a receiving device connects to a channel that is transferring the video pictures.

### SUMMARY

The method provides for groups of pictures to be formed, wherein a relevant group of pictures includes a plurality of temporally consecutive pictures in an original temporal order. In this context, the original temporal order corresponds to the actual temporal course of the scenarios that are represented in the video stream.

In the method, each group of pictures is coded, i.e. by forming a prediction structure in which one or more pictures of the group of pictures are specified as intrapictures which are intracoded in each case, and the other pictures of the group of pictures are specified as interpictures which are predicted from at least one reference picture of the group of pictures and are intercoded relative to the at least one reference picture. According to the method, the prediction structure is configured such that:

i) each intrapicture is a reference picture, from which are predicted at least one picture which is temporally earlier than the intrapicture in the group of pictures, and at least one picture which is temporally later than the intrapicture in the group of pictures;

ii) the interpictures include a plurality of non-referenced pictures, from which no pictures of the series are predicted.

A transfer sequence having a temporal transfer order is then formed from the coded pictures of the group of pictures, wherein at least some of the coded non-referenced pictures are the first pictures of the transfer order. In this context, transfer order is understood to mean the order in which the pictures are subsequently to be transferred after the coding.

By virtue of non-referenced pictures being situated at the beginning of the series of pictures, it is often possible to render this group of pictures in reduced resolution when connecting into a group of pictures, because those pictures which are not required for decoding other pictures are transferred at the beginning of the group of pictures. Furthermore, smooth playback of the pictures becomes possible because the intrapicture is not arranged at the boundary of the series of pictures, and at least one temporally earlier and once temporally later picture are predicted from the intrapicture.

In an embodiment, the coded intrapicture (or intrapictures) is arranged as the last picture (or pictures) of the transfer order. Consequently, even when connecting into a group of pictures at a late time point, it is still possible to render at least the intracoded picture of the group of pictures.

In a further embodiment of the method, all coded non-referenced pictures are arranged as the first pictures at the beginning of the transfer order. In a variant, provision is further made for an essentially central arrangement of the intrapicture. If there is an uneven number of pictures in the group of pictures, this involves using the central picture of the group of pictures as the intrapicture, and if there is an even number of pictures in the group of pictures, the intrapicture is located at that position—in the group of pictures—which corresponds to the result of the division of the number of pictures of the group of pictures by two, or to this result plus one.

In a further embodiment, the groups of pictures include as interpictures not only non-referenced pictures, but also those pictures from which one or more pictures of the group of pictures are predicted. In the transfer order, these coded reference pictures may be arranged between the at least several coded non-referenced pictures and the coded intrapicture or intrapictures. In this way, a hierarchy of the pictures is effected, reflecting the importance of the corresponding pictures in the decoding. The more important a picture in the context of decoding, the later it is arranged in the transfer order.

In a further embodiment, redundancy data is generated in each case for the groups of pictures for the purpose of error protection when transferring the group of pictures concerned, wherein the redundancy data is inserted into the transfer order when the transfer sequence is generated. In this context, it is advantageous for at least part of the redundancy data in the transfer order to be arranged before the first pictures because, when connecting into a group of pictures, the actual picture information then follows at a later time point than it would if the redundancy information was situated at the end of the group of pictures.

In a further embodiment, a relevant group of pictures can be scaled into a plurality of resolution levels, wherein the lowest resolution level includes only the coded intrapicture or intrapictures, and each higher resolution level is wherein a number of coded pictures which are added at the higher resolution level in comparison with the next lower resolution level. An advantageous combination of the method with scalable video coding is achieved in this way. According to the method, the coded pictures in the transfer sequence may be arranged into subsequences, these being assigned a resolution level in each case, wherein a relevant subsequence includes the coded pictures which, in comparison with the next lower resolution level, are added at the resolution level that is assigned to the relevant subsequence, wherein the subsequences in the transfer order are arranged in descending order of the resolution levels. This ensures that the highest possible temporal resolution of the pictures is maintained when connecting into a group of pictures.

In a further embodiment, separate redundancy data is generated in each case for at least some of the subsequences, the data being arranged in each case in front of the corresponding subsequence in the transfer order. As a result, it is possible to achieve a flexible specification of the error protection according to resolution level by virtue of the separate redundancy data featuring at least partially different degrees of error protection, wherein the degree of error protection for the redundancy data of a subsequence may decrease as the resolution level of the subsequence increases.

In a further embodiment, regular temporal scalability is ensured in that the resolution levels are characterized by a factor, such that all resolution levels except for the lowest include a number of pictures which can be divided by the factor without a remainder.

In a further embodiment of the method, the prediction structure is specified in such a way that at least one non-referenced picture is assigned a predetermined number of pictures, the non-referenced picture being predicted from that picture, among the predetermined number of pictures, which was generated from the smallest number of predictions. Consequently, for the purpose of predicting a picture, a picture is always used which was derived from the fewest possible preceding prediction steps. This results in increased error resilience, since the error propagation is lower in the event of an invalid transfer. In this context, the predetermined number of pictures may be the two reference pictures which are situated temporally closest to the non-referenced picture in the series of pictures, i.e. the two temporally closest pictures which are not non-referenced pictures.

In a further embodiment, at least some interpictures are predicted in each case from a plurality of other pictures, wherein a relevant interpicture of the at least some interpictures is divided into a multiplicity of blocks and, for each block, an individual picture from which the block is predicted is specified from the plurality of other pictures. The method is thus combined with the prediction using Multiple Reference Frames as mentioned in the introduction.

In addition to the above-described method for video coding, a method is herein described for transmitting a series of digitized pictures, wherein the series of digitized pictures is coded in accordance with the method and the pictures are then transmitted in the temporal transfer order of the transfer sequence. In this context, the transmission may take place via a broadcast service on one or more broadcast channels.

In addition to the above-described method for video coding, a method is herein described for decoding a series of digitized pictures which were decoded and transmitted using the method. In the decoding method, the transfer sequences of the coded pictures of the groups of pictures of the series are received. The coded pictures of each transfer sequence are then decoded depending on the prediction structure being used. Finally, the decoded pictures of each transfer sequence are read out in the original temporal order of the group of pictures, thereby recreating the original video stream.

In addition the method further includes a corresponding transmitter for transmitting a series of digitized pictures, wherein the transmitter performs the coding method described herein and the subsequent transmission of the coded pictures in accordance with any variant of the method.

Also described below is a receiver for receiving and decoding a series of digitized pictures that was transmitted using the method, the receiver being configured in such a way that it performs the above-described decoding method.

### BRIEF DESCRIPTION OF THE DRAWINGS

These and other aspects and advantages will become more apparent and more readily appreciated from the following description of the exemplary embodiments, taken in conjunction with the accompanying drawings of which:

FIGS. 1 to 4 are representational views of groups of pictures which are coded in accordance with methods as per the related art;

FIGS. 5 to 12 are representational views of groups of pictures which are coded in accordance with embodiments of the method; and

FIG. 13 is a block diagram of a transfer system for a video stream, including a transmitter and a receiver.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

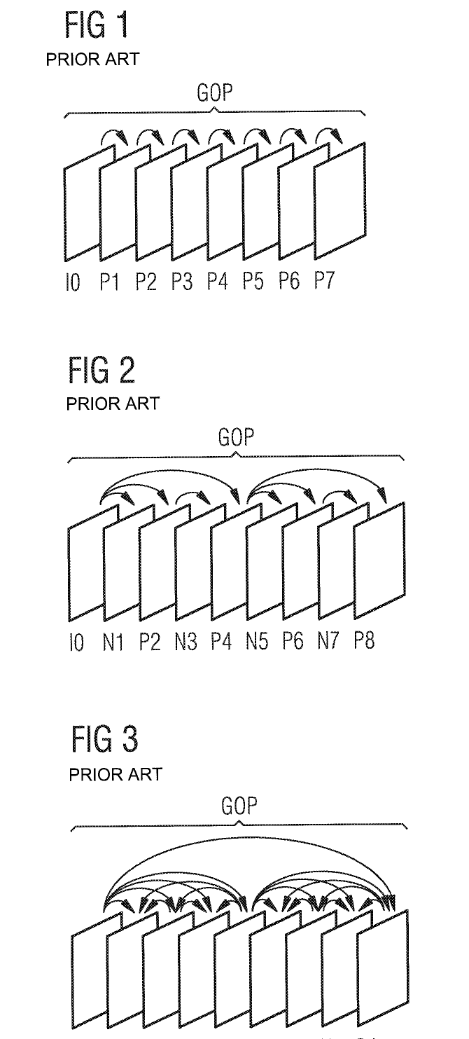

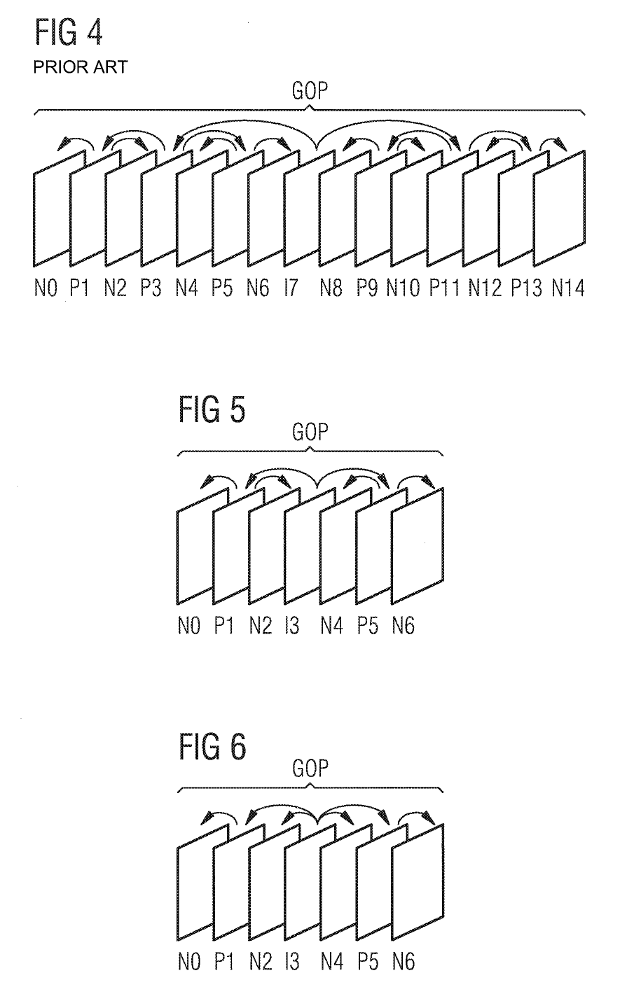

FIGS. 1 to 4 show various groups of pictures GOP, which are coded using methods as per the related art. FIGS. 1 to 4 were already explained above and therefore these figures are not discussed further.

FIG. 5 shows a group of pictures in a series of pictures which is coded in accordance with an embodiment of the method. The illustrated prediction structure is already disclosed in the Bergeron et al. publication, wherein the group of pictures GOP includes seven pictures and a tree-like prediction is formed by virtue of the picture in the middle of the group of pictures being the intrapicture I3, from which the temporally preceding picture P1 and the temporally succeeding picture P5 are predicted. The non-referenced pictures N0 and N2 are in turn predicted from the picture P1, and the non-referenced pictures N4 and N6 are predicted from the picture P5. On the basis of the prediction structure as per FIG. 5, provision is made for generating a transfer order which includes two separate redundancy blocks FEC1 and FEC2, and in which the non-referenced pictures are located at the beginning of the transfer order. The transfer order is as follows:

FEC2 N0 N2 N4 N6 FEC1 P1 P5 I3.

The redundancy block FEC2 protects the non-referenced pictures here, and the redundancy block FEC1 protects the intrapicture and the pictures P1 and P5 which are used for predicting the non-referenced pictures.

Because the pictures are not decoded in the original order of the series of pictures in the receiver, the pictures must be stored in a so-called playout buffer on the receiver side for subsequent display. In this case, the intrapicture I3 must be stored first, after it has been decoded. After the subsequent decoding of the interpicture P1, I3 and P1 remain in the memory. During the subsequent decoding of the non-referenced picture N0, this picture is likewise stored in the playout buffer and, after completion of the decoding, is read out for display and deleted from the buffer. Next, a series of contents is shown, rendering the contents of the playout buffer after each decoding of a picture. The contents of the buffer at the relevant time points are grouped together in parentheses, wherein the picture located at the right-hand end of a set of parentheses is the picture which was decoded at the relevant time point. Furthermore, an underscore indicates which picture is read out and deleted from the buffer after the decoding at the relevant time point. The following model, indicating the series of contents, is used in relation to the description of the further embodiments. The series of contents of the playout buffer for the series of pictures as per FIG. 5 is as follows:

(I3) (I3 P1) (I3 P1 N0) (I3 P1 N2) (I3 N2 P5) (I3 P5 N4) (P5 N4 N6) (P5 N6) (N6).

This means that a playout buffer of three decoded pictures must be provided for the embodiment as per FIG. 5.

In the embodiment above, the first redundancy block FEC1 protects the pictures I3, P1 and P5, and the second redundancy block FEC2 protects the pictures N0, N2, N4 and N6. Because the latter pictures are not used for the prediction of other pictures, the protection for these pictures may be weaker. The error protection FEC2 can optionally be omitted completely, in which case only the reference pictures I3, P1 and P5 are protected. This results in Unequal Error Protection (UEP). By contrast, both error protection blocks FEC1 and FEC2 are combined into one error protection block FEC in the case of Equal Error Protection (EEP). Assuming that a picture is lost during the transfer (also assuming an equal distribution in the loss of pictures), this results in an expected value E of disrupted pictures as follows:

E=1/7·(4·1+2·3+1·7)=2.43.

FIG. 6 shows a second variant featuring a prediction structure which is a modification of the prediction structure as per FIG. 5. In the prediction structure as per FIG. 6, use is made of so-called shortened prediction paths. This means that, when predicting a non-referenced picture, an attempt is always made to use, as a reference picture, a picture which itself was derived from a small number of predictions. In the example as per FIG. 6, the non-referenced pictures N2 and N4 are predicted in each case from that of the two adjacent pictures which is derived from fewer predictions. In other words, in FIG. 6 the picture N2 is not predicted from the picture P1 (unlike FIG. 5) but from the picture I3, and the picture N4 is not predicted from the picture P5 but from the picture I3. This has the effect of increasing the error resilience, because if one or more pictures are lost, the probability that the remaining pictures can be decoded increases. In comparison with the embodiment according to FIG. 5, the expectation value E of disrupted pictures is derived as follows:

E=1/7·(4·1+2·2+1·7)=2.14.

Consequently, the error susceptibility is reduced in the embodiment as per FIG. 6 in comparison with the embodiment as per FIG. 5.

In this context, the transfer order in the embodiment as per FIG. 6 is selected as follows:

FEC2 N0 N2 N4 N6 FEC1 P1 P5 P6 I3.

In this case, the series of contents of the playout buffer in the receiver is as follows:

(I3) (I3 P1) (I3 P1 N0) (I3 P1 N2) (I3 N2 N4) (I3 N4 P5) (N4 P5 N6) (P5 N6) (N6).

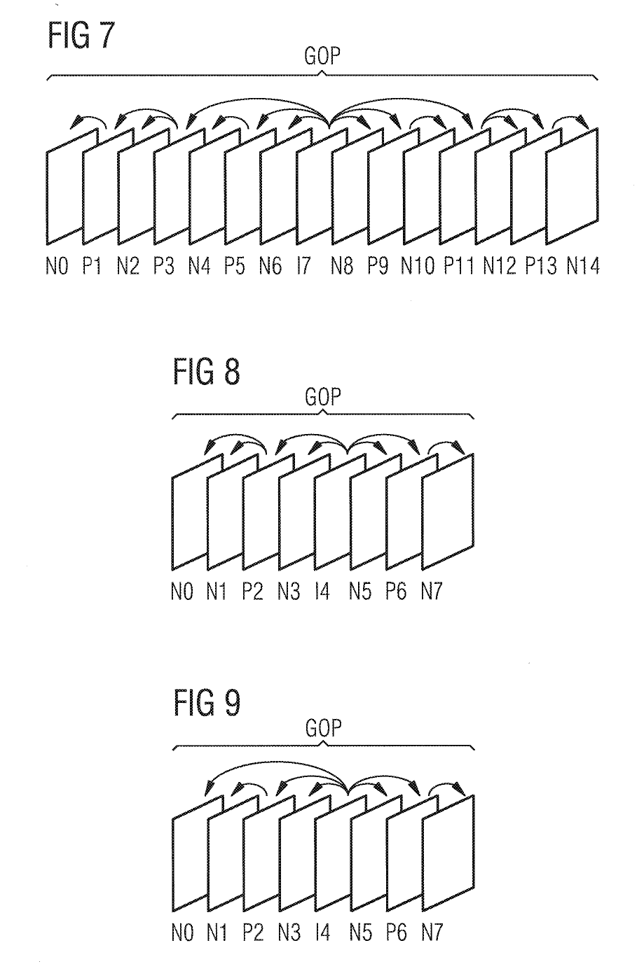

FIG. 7 shows a prediction structure according to the same principle as FIG. 6 featuring shortened prediction paths, wherein the length of the group of pictures is now increased to fifteen pictures, however. A larger number of temporal scalability levels are produced in this case, and more possibilities for dividing the error protection among the individual scalability levels.

FIG. 8 shows a prediction structure featuring a three-level regular scalability. In this context, regular scalability means that the temporal resolution remains constant across the consecutive groups of pictures GOP and, in particular, that no enlarged gaps occur between the groups of pictures. In the example according to FIG. 8, a dyadic temporal scalability is produced in this context. Dyadic means that the number of pictures in the relevant scalability level or resolution level (except for the lowest) is always divisible by two. According to FIG. 8, the lowest and first scalability level is represented by the intrapicture I4 in this context, the second scalability level is formed by the picture I4 and the further pictures N0, P2 and P6, and the third scalability level is formed by the pictures of the lowest and the second scalability level and the pictures N1, N3, N5 and N7. According to the method, the pictures of the group of pictures in FIG. 8 are arranged in the following transfer order with corresponding redundancy blocks FEC1 and FEC2:

FEC2 N1 N3 N5 N7 FEC1 N0 P2 P6 P4.

In this case, the series of contents of the playout buffer in the receiver is as follows:

(I4) (I4 P2) (I4 P2 N0) (I4 P2 N1) (I4 P2 N3) (I4 N3 N5) (I4 N5 P6) (N5 P6 N7) (P6 N7) (N7).

In this context, the first redundancy block FEC1 protects the pictures I4, P2, N0 and P6, while the second redundancy block FEC2 protects the pictures N1, N3, N5 and N7. Because the latter pictures are not used for prediction by other pictures, the protection for these pictures is weaker. This produces an Unequal Error Protection. In the case of Equal Error Protection, the two error protection blocks FEC1 and FEC2 can be combined into one error protection block FEC.

FIG. 9 shows a prediction structure featuring further temporal scalability levels. The prediction structure in FIG. 9 contains four scalability levels in total. Unlike FIG. 8, the non-referenced picture N0 is predicted directly from the picture I4 and not from the picture P2. A further scalability level is produced as a result of this. According to FIG. 9, the lowest and first scalability level consists of the picture I4. The second scalability level includes the pictures I4 and N0. The pictures P2 and P6 are added in the third scalability level. The fourth scalability level is supplemented by the pictures N1, N3, N5 and N7. As a result of the further scalability level, a separate further error protection block FEC3 can be created. In this context, the transfer order is selected as follows:

FEC3 N1 N3 N5 N7 FEC2 P2 P6 FEC1 N0 I4.

In this case, the series of contents of the playout buffer is as follows:

(I4) (I4 N0) (I4 P2) (I4 P2 N1) (I4 P2 N3) (I4 N3 N5) (I4 N5 P6) (N5 P6 N7) (P6 N7) (N7).

Unequal Error Protection can also be achieved in this variant. In this case, the redundancy block FEC1 protects the pictures I0 and I4, FEC2 protects the pictures P2 and P6, and FEC3 protects the pictures N1, N3, N5 and N7.

By a small modification to the prediction structure as per FIG. 9, the demands on the playout buffer can be reduced, specifically by the picture N1 being predicted not from the picture P2, but from the picture N0 (i.e. the picture N0 then becomes the picture P0).

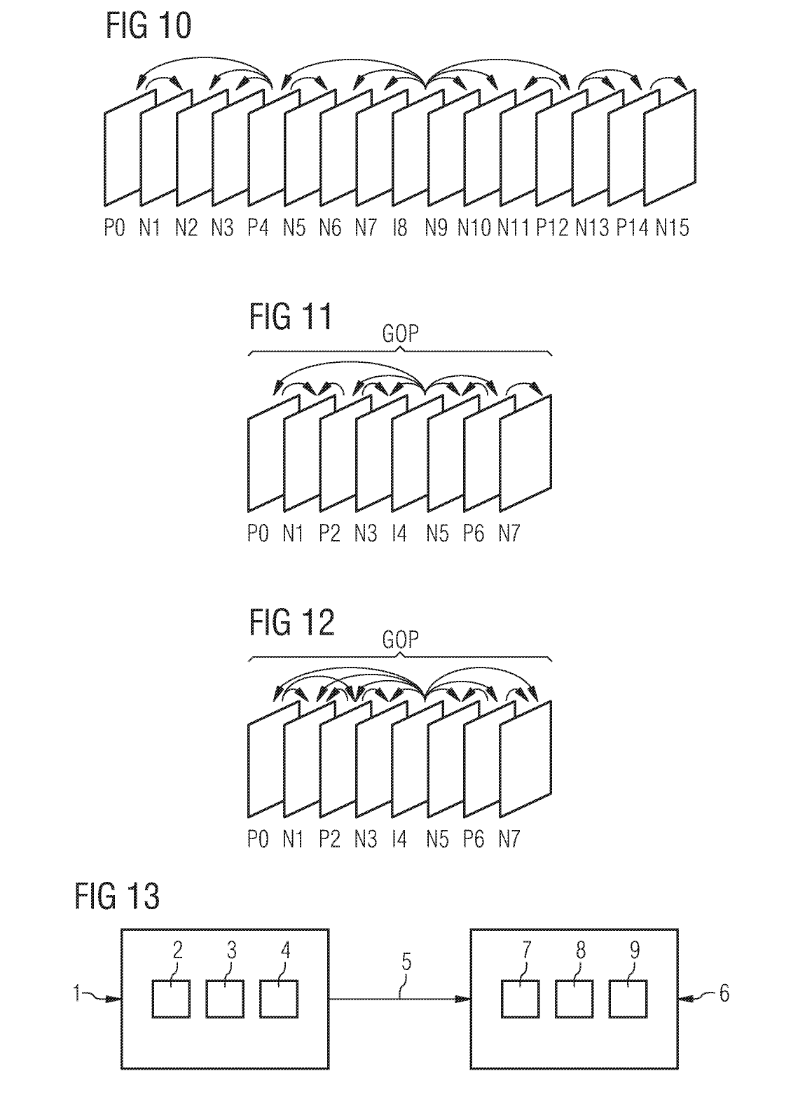

FIG. 10 shows a further embodiment, featuring a prediction structure for multilevel dyadic temporal scalability, wherein the length of the group of pictures now includes 16 pictures.

According to the method, the following transfer order is generated for FIG. 10:

FEC3 N1 N3 N5 N7 N9 N11 N13 N15 FEC2 N2 N6 N10 P14 FEC1 P0 P4 P12 I8.

In this case, the series of contents of the playout buffer is as follows:
(I8) (I8 P4) (I8 P4 P0) (I8 P4 N1) (I8 P4 N2) (I8 P4 N3) (I8 P4 N5) (I8 N5 N6) (I8 N6 N7) (I8 N7 N9) (I8 N9 N10) (N9 N10 P12) (N10 P12 N11) (P12 N11 N13) (P12 N13 P14) (N13 P14 N15) (P14 N15) (N15).

FIGS. 11 and 12 show prediction structures which use the above-described Multiple Reference Frames, wherein a plurality of reference pictures can be used for the prediction of a picture. In this context, FIG. 11 shows a prediction structure for a multi-level dyadic temporal scalability, in which two pictures are used for predicting the pictures N1, N3 and N5, and one picture is used for predicting the other interpictures. By contrast, FIG. 12 shows a prediction for a multilevel dyadic temporal scalability, in which the picture P1 is predicted from three pictures, the picture P2 from two pictures, the picture N3 from two pictures, the picture N5 from two pictures, the picture N7 from two pictures, and the other interpictures from one picture.

For FIGS. 11 and 12, the following transfer order is generated for the pictures of the group of pictures GOP:

FEC3 N1 N3 N5 N7 FEC2 P2 P6 FEC1 P0 I4.

In this case, the series of contents of the playout buffer is as follows:

(I4) (I4 P0) (I4 P0 P2) (I4 P2 N1) (I4 P2 N3) (I4 N3 N5) (I4 N5 P6) (N5 P6 N7) (P6 N7) (N7).

A plurality of advantages are derived from the above-described variants. Smoother playback of the pictures is permitted when connecting to a broadcast channel. Furthermore, as a result of the even (e.g. dyadic) temporal scalability, it becomes possible to support a plurality of scalability levels. If e.g. the error protection for non-referenced pictures is inadequate for decoding these correctly, it is possible to display just the remaining video stream using half the temporal resolution (half of the picture refresh rate). In the case of non-regular temporal scalability, the pictures would be displayed at irregular time intervals, which is perceived as disruptive. If applicable, it is also possible to define two different service classes, one class relating to the full temporal resolution and the other to the reduced temporal resolution. A further advantage of the above variants featuring shortened prediction paths is an increase in the error resilience of the transfer.

FIG. 13 shows a schematic illustration of a transfer system. The system includes a transmitter 1 for transmitting a video stream of coded pictures. This transmitter has a processor that functions as a picture generation means 2 for generating groups of pictures, wherein a relevant group of pictures includes a plurality of temporally consecutive pictures in an original temporal order. The transmitter 1 additionally contains a processor that functions as a coding means 3 for coding each group of pictures, in that provision is made for generating a prediction structure, according to which one or more pictures of the group of pictures are specified as intrapictures, these being intracoded, and the other pictures of the group of pictures are specified as interpictures, these being predicted in each case from at least one reference picture of the group of pictures and intercoded relative to the at least one reference picture, wherein the prediction structure is configured in such a way that:

i) each intrapicture is a reference picture, from which are predicted at least one picture which is temporally earlier than the intrapicture in the group of pictures, and at least one picture which is temporally later than the intrapicture in the group of pictures;

ii) the interpictures include a plurality of non-referenced pictures, from which no pictures of the series are predicted.

The transmitter additionally includes a transmitter or transmission means 4 for transmitting the coded pictures, the transmission means being configured such that a transfer sequence having a temporal transfer order is formed from the coded pictures of each group of pictures, and the coded pictures are transmitted in the transfer order, wherein at least some of the coded non-referenced pictures are the first pictures of the transfer order.

The pictures are transferred from the transmitter 1 via a transfer link 5, e.g., via one or more broadcast channels. These broadcast channels can be received by a receiver 6, and the data stream which is coded therein can be read out by the receiver 6. For this purpose, the receiver 6 includes a receiver or receiving means 7 for receiving the transfer sequences of the coded pictures of the groups of pictures of the video stream, a decoder or decoding means 8 for decoding the pictures of each transfer sequence depending on the prediction structure, and a reader or reading means 9 for reading out the decoded pictures of each transfer sequence in the original temporal order of the group of pictures.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-22. (canceled)

23. A method for video-coding a series of digitized pictures, comprising:
forming groups of pictures in which a relevant group of pictures includes a plurality of temporally consecutive pictures in an original temporal order;
coding each group of pictures to generate coded pictures with a prediction structure in which at least one coded picture of the group of pictures is defined as an intrapicture which is intracoded in each intrapicture, and all other pictures of the group of pictures are defined as interpictures which are predicted in each case from at least one reference picture of the group of pictures and are intercoded relative to the at least one reference picture, the prediction structure being configured such that
each intrapicture is a reference picture, from which are predicted at least one picture which is temporally earlier than the intrapicture in the group of pictures, and at least one picture which is temporally later than the intrapicture in the group of pictures, and
the interpictures include a plurality of coded non-referenced pictures, from which no pictures of the series are predicted; and
forming a transfer sequence, having a temporal transfer order, from the coded pictures of the group of pictures, with at least some of the coded non-referenced pictures as the first pictures of the transfer order.

24. The method as claimed in claim 23, wherein the at least one coded intrapicture is at the end of the transfer order.

25. The method as claimed in claim 24, wherein all coded non-referenced pictures are the first pictures of the transfer order.

26. The method as claimed in claim 25, wherein the group of pictures contains an intrapicture which, if there is an uneven number of pictures in the group of pictures, is centered in the group of pictures and, if there is an even number of pictures in the group of pictures, a preceding number of pictures differs from a following number of pictures by one.

27. The method as claimed in claim 26, wherein the at least one coded intrapicture includes at least one reference picture from which at least one picture of the group of pictures is predicted.

28. The method as claimed in claim 27, wherein the coded reference pictures from the interpictures in the temporal transfer order are arranged between at least several coded non-referenced pictures and the at least one coded intrapicture.

29. The method as claimed in claim 28, further comprising:
generating redundancy data for each of the groups of pictures to provide error protection when transferring the group of pictures; and
inserting the redundancy data into the temporal transfer order when the transfer sequence is generated.

30. The method as claimed in claim 29, wherein at least part of the redundancy data in the transfer order is arranged before the first pictures.

31. The method as claimed in claim 30, further comprising producing a relevant group of pictures scaled into a plurality of resolution levels with a lowest resolution level including only the at least one coded intrapicture and each higher resolution level having a number of the coded pictures added in the higher resolution level in comparison with the next lower resolution level.

32. The method as claimed in claim 31, further comprising arranging the coded pictures in the temporal transfer sequence into subsequences in descending order of resolution levels, each subsequence assigned a resolution level, where a relevant subsequence includes the coded pictures which, in comparison with a next lower resolution level, are added to a current resolution level assigned to the relevant subsequence.

33. The method as claimed in claim 32, wherein said generating produces separate redundancy data for at least some of the subsequences, the redundancy data being arranged in each case in front of a corresponding subsequence in the temporal transfer order.

34. The method as claimed in claim 33, wherein the separate redundancy data features at least partially different degrees of error protection.

35. The method as claimed in claim 34, wherein the degree of error protection for the redundancy data of a subsequence decreases as the resolution level of the subsequence increases.

36. The method as claimed in claim 35, wherein the resolution levels have a factor, such that all resolution levels except for the lowest resolution level include a number of pictures which can be divided by the factor without a remainder.

37. The method as claimed in claim 36, wherein the prediction structure is specified so that at least one non-referenced picture is assigned a predetermined number of pictures, the at least one non-referenced picture being predicted from one picture among the predetermined number of pictures, which was generated from a smallest number of previous predictions.

38. The method as claimed in claim 37, wherein the predetermined number of pictures is two reference pictures which are situated temporally closest to the non-referenced picture in the group of pictures.

39. The method as claimed in claim 38, wherein at least some interpictures are predicted in each case from a plurality of other pictures, with a relevant interpicture of the at least some interpictures divided into a multiplicity of blocks and, for each block, an individual picture from which the block is predicted is specified from the plurality of other pictures.

40. A method as claimed in claim 23, further comprising transmitting the coded pictures in the temporal transfer order of the transfer sequence.

41. The method as claimed in claim 40, wherein the transmission takes place via at least one broadcast channel.

42. A method for decoding a series of digitized pictures transmitted in a temporal sequence after video-coding by forming groups of pictures in which a relevant group of pictures includes a plurality of temporally consecutive pictures in an original temporal order; coding each group of pictures to generate coded pictures with a prediction structure in which at least one coded picture of the group of pictures is defined as an intrapicture which is intracoded in each intrapicture, and all other pictures of the group of pictures are defined as interpictures which are predicted in each case from at least one reference picture of the group of pictures and are intercoded relative to the at least one reference picture, the prediction structure being configured such that each intrapicture is a reference picture, from which are predicted at least one picture which is temporally earlier than the intrapicture in the group of pictures, and at least one picture which is temporally later than the intrapicture in the group of pictures, and the interpictures include a plurality of coded non-referenced pictures, from which no pictures of the series are predicted; and forming a transfer sequence, having a temporal transfer order, from the coded pictures of the group of pictures, with at least some of the coded non-referenced pictures are the first pictures of the transfer order, said method comprising:
receiving the transfer sequences of the coded pictures of the groups of pictures of the series;
decoding the coded pictures of each transfer sequence depending on the prediction structure; and
reading the decoded pictures of each transfer sequence in the original temporal order of the group of pictures.

43. A transmitter for transmitting a series of digitized pictures, comprising:
means for generating groups of pictures in which a relevant group of pictures includes a plurality of temporally consecutive pictures in an original temporal order;
means for coding each group of pictures to generate coded pictures with a prediction structure in which at least one coded picture of the group of pictures is defined as an intrapicture which is intracoded in each intrapicture, and all other pictures of the group of pictures are defined as interpictures which are predicted in each case from at least one reference picture of the group of pictures and are intercoded relative to the at least one reference picture, the prediction structure being configured such that
each intrapicture is a reference picture, from which are predicted at least one picture which is temporally earlier than the intrapicture in the group of pictures, and at least one picture which is temporally later than the intrapicture in the group of pictures, and
the interpictures include a plurality of coded non-referenced pictures, from which no pictures of the series are predicted; and
means for transmitting the coded pictures in a transfer sequence having a temporal transfer order formed from the coded pictures of each group of pictures with at least some of the coded non-referenced pictures as the first pictures of the transfer order.

44. A receiver for receiving and decoding a series of digitized pictures transmitted in a temporal sequence after video-coding by forming groups of pictures in which a relevant group of pictures includes a plurality of temporally consecutive pictures in an original temporal order; coding each group of pictures to generate coded pictures with a prediction structure in which at least one coded picture of the group of pictures is defined as an intrapicture which is intracoded in each intrapicture, and all other pictures of the group of pictures are defined as interpictures which are predicted in each case from at least one reference picture of the group of pictures and are intercoded relative to the at least one reference picture, the prediction structure being configured such that each intrapicture is a reference picture, from which are predicted at least one picture which is temporally earlier than the intrapicture in the group of pictures, and at least one picture which is temporally later than the intrapicture in the group of pictures, and the interpictures include a plurality of coded non-referenced pictures, from which no pictures of the series are predicted; and forming a transfer sequence, having a temporal transfer order, from the coded pictures of the group of pictures, with at least some of the coded non-referenced pictures are the first pictures of the transfer order, said receiver comprising:
means for receiving the transfer sequences of the coded pictures of the groups of pictures of the series;
means for decoding the coded pictures of each transfer sequence depending on the prediction structure; and
means for reading the decoded pictures of each transfer sequence in the original temporal order of the group of pictures.
